(19) United States
(12) Patent Application Publication
(10) Pub. No.: US 2026/0086346 A1
(43) Pub. Date: Mar. 26, 2026

(54) SYSTEMS AND METHODS FOR PROBE DETECTION

(71) Applicant: Alcon Inc., Fribourg (CH)

(72) Inventors: David Jung, Tustin, CA (US); John Hossein Karim, Cypress, CA (US); Christopher Andrew Guerrero, Laguna Niguel, CA (US)

(21) Appl. No.: 19/312,914

(22) Filed: Aug. 28, 2025

Related U.S. Application Data
(60) Provisional application No. 63/698,138, filed on Sep. 24, 2024.

(51) Int. Cl. G02B 23/24; H05B 45/325; H05B 47/11

(52) U.S. Cl. CPC G02B 23/2469; G02B 23/243; H05B 45/325; H05B 47/11

(57) ABSTRACT

Embodiments provide systems and methods for probe detection for laser-based surgical systems. In certain embodiments, an optical port includes an optical receptacle configured to receive a detachable optical connector, a first light source configured to emit a first pulsed light beam along a first optical path through the optical receptacle, a first optical sensor located in the first optical path, a second light source configured to emit a second pulsed light beam along a second optical path through the optical receptacle, and a second optical sensor located in the second optical path. The detachable optical connector blocks the first optical path and the second optical path when the detachable optical connector is attached to the optical receptacle, and the first pulsed light beam and the second pulsed light beam include light beam pulses that are emitted at different times.

### BACKGROUND

The present disclosure relates to surgical systems. More particularly, the present disclosure relates to systems and methods for probe detection for surgical systems that utilize one or more forms of light (e.g., laser light, light emitting diode (LED) light, etc.) for treatment, illumination, etc.

In a wide variety of medical procedures, laser light may be used to treat patient anatomy, LED light may be used to provide illumination, etc. For example, an ophthalmic surgical system may include a control system and a laser subsystem, and may include other subsystems, such as a surgical tool subsystem, a fluidic subsystem, a visualization subsystem, etc. The laser subsystem includes and/or couples, via one or more optical cables, to one or more probes that provide laser light to the patient for treatment, illumination light for illuminating the ocular space, etc. For example, in laser photocoagulation, the laser subsystem generates a laser treatment beam that travels through an optical fiber within an optical cable to a laser probe for cauterizing blood vessels at a burn spot across the patient’s retina. In laser vitrectomy, the laser subsystem generates a laser treatment beam that travels through an optical fiber within an optical cable to a laser probe for cutting the patient’s vitreous. In laser cataract surgery, the laser subsystem generates a laser treatment beam that travels through an optical fiber within an optical cable to a laser probe for breaking up and softening the pieces of the patient’s lens. Similarly, the laser probe or a separate illumination probe may provide illumination light of various wavelengths to the treatment site. In such examples, an illumination beam is generated by the laser subsystem and travels through an optical fiber within an optical cable to the probe, which is manipulated by a surgeon.

Generally, each of the one or more optical cables described above has an optical connector to attach the optical cable to a corresponding optical connector of an optical port of the laser subsystem. Further, in many laser-based surgical systems, the laser subsystem detects whether an optical cable is attached to the optical port and conveys this information to the control system.

In such systems, a combination of a light source (such as a light emitting diode or LED, a laser diode, etc.) and an optical sensor (such as a photoelectric sensor, a photodiode, an infrared sensor, etc.) may be used to detect whether an optical cable is attached to the optical port. The light source emits a continuous beam of visible or infrared light toward the optical sensor. The optical sensor receives and converts the light into an electric signal, which is provided to the control system within the laser subsystem. The light source and optical sensor pair are arranged on the corresponding optical connector of the optical port such that the light beam illuminates the optical sensor when the optical connector of the optical cable is not attached to the corresponding optical connector of the optical port, but the optical connector blocks the light beam from illuminating the optical sensor when the optical connector is attached to the corresponding optical connector of the optical port. In other words, the optical connector of the optical cable blocks the optical path between the light source and the optical sensor when attached to the corresponding optical connector of the optical port.

### SUMMARY

Embodiments of the present disclosure advantageously provide systems and methods for probe detection for surgical systems that utilize one or more forms of light (e.g., laser light, light emitting diode (LED) light, etc.) for treatment, illumination, etc.

In certain embodiments, an optical port includes an optical receptacle configured to receive a detachable optical connector, a first light source configured to emit a first pulsed light beam along a first optical path through the optical receptacle, a first optical sensor located in the first optical path, a second light source configured to emit a second pulsed light beam along a second optical path through the optical receptacle, and a second light source located in the second optical path. The detachable optical connector blocks the first optical path and the second optical path when the detachable optical connector is attached to the optical receptacle, and the first pulsed light beam and the second pulsed light beam include light beam pulses that are emitted at different times.

### BRIEF DESCRIPTION OF THE DRAWINGS

FIG. 1 illustrates an example surgical system for performing a laser-assisted ophthalmic surgical procedure, in accordance with certain embodiments of the present disclosure.

FIGS. 2A, 2B illustrate cross-sectional side views of an example optical port of a laser subsystem and an example optical connector of a laser probe, in accordance with certain embodiments of the present disclosure.

FIG. 3A depicts a top perspective view of a portion of an optical port for an example laser subsystem, in accordance with certain embodiments of the present disclosure.

FIG. 3B depicts another top perspective view of the portion of the optical port depicted in FIG. 3A, in accordance with certain embodiments of the present disclosure.

FIG. 4A depicts a perspective view of an optical connector attached to an optical port for an example laser subsystem, in accordance with certain embodiments of the present disclosure.

FIG. 4B depicts a perspective sectional view of the optical connector depicted in FIG. 4A, in accordance with certain embodiments of the present disclosure.

FIG. 5A depicts a block diagram of a portion of an example optical port, in accordance with certain embodiments of the present disclosure.

FIG. 5B depicts a block diagram of a portion of another example optical port, in accordance with certain embodiments of the present disclosure.

FIG. 6 depicts an example timing diagram for the emission and reception of pulsed light beams for laser probe detection, in accordance with certain embodiments of the present disclosure.

FIG. 7 depicts process an example flow diagram presenting functionality associated with detecting a probe in a laser-based surgical system, in accordance with certain embodiments of the present disclosure.

### DETAILED DESCRIPTION

Embodiments of the present disclosure will now be described with reference to the figures, in which like reference numerals refer to like parts throughout.

In certain laser subsystems, to detect whether an optical cable is coupled to the connector of the laser subsystem, two pairs of light sources and optical sensors may be arranged on the corresponding connector of the optical port such that the continuous light beams are perpendicular to one another. The optical sensors may generate a high electrical signal when the light beam illuminates the optical sensor (indicating the absence of the optical connector), and a low electrical signal when the light beam does not illuminate the optical sensor (indicating the presence of the optical connector).

Unfortunately, this arrangement may present several difficulties, such as degradation of the light sources due to the emission of continuous light beams, beam confliction at the location of the optical connector, ambiguity related to whether the optical connector is present or absent when one of the light sources or optical sensors is malfunctioning (such as a false detection of the presence of the optical connector due to an optical sensor malfunction, etc.), installation issues when mounting the light sources and the optical sensors to the corresponding optical connector of the optical port, as well as other difficulties.

Embodiments of the present disclosure advantageously provide systems and methods for probe detection for surgical systems that utilize one or more forms of light (e.g., laser light, light emitting diode (LED) light, etc.) for treatment, illumination, etc. In certain embodiments, an optical port includes a first light source, a first optical sensor, a second light source, and a second optical sensor. The first light source generates a first pulsed light beam that is received by the first optical sensor, and the second light source generates a second pulsed light beam that is received by the second optical sensor. The data signals generated by the optical sensors may be used to determine whether the optical connector is attached to the optical port. Light sources that emit pulsed light beams significantly reduce the degradation of the light sources, eliminate beam confliction at the location of the optical connector, eliminate ambiguity related to whether the optical connector is present or absent when one of the light sources or optical sensors is malfunctioning, improve installation through surface mounting, and provide other advantages as well.

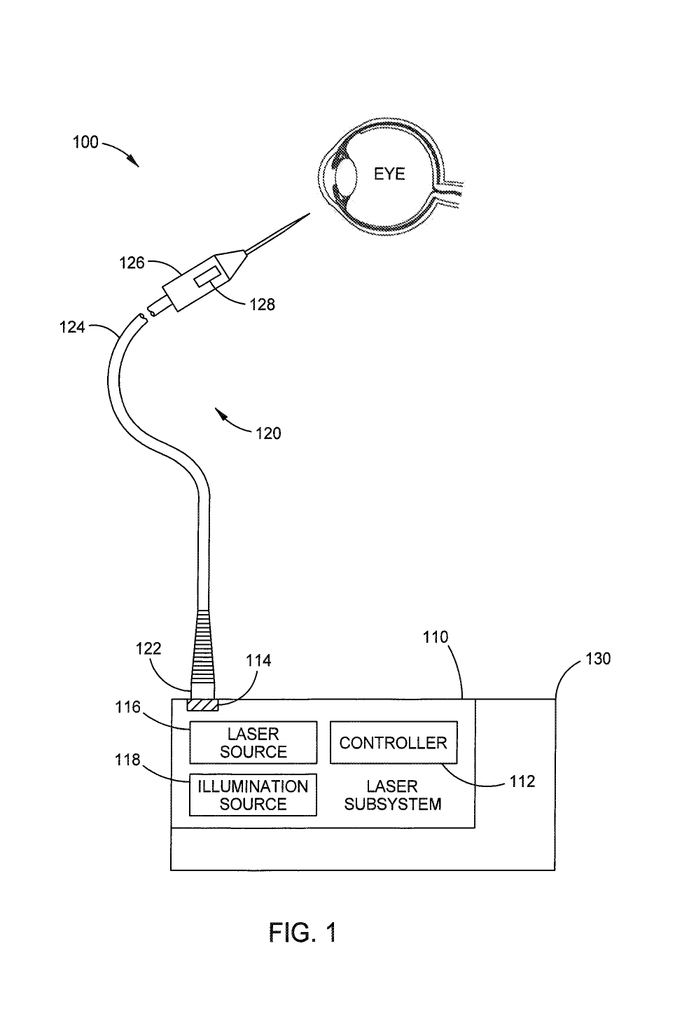

FIG. 1 illustrates an example surgical system 100 for performing a laser-assisted ophthalmic surgical procedure. Although illustrated as an ophthalmic surgical procedure, the systems and methods described herein may be utilized in combination with, or for, any suitable surgical instruments, or other instruments, having light emitting functionality.

In certain embodiments, surgical system 100 may include, inter alia, laser subsystem 110 and laser probe 120, which may be attached and detached from laser subsystem 110.

Laser subsystem 110 may include, inter alia, controller 112, one or more optical ports 114, and one or more laser sources 116. Each laser source 116 is coupled to an optical port 114. In some embodiments, laser subsystem 110 may include one or more illumination sources 118 in addition to, or in place of, laser source 116. Each illumination source 118 is coupled to an optical port 114.

Controller 112 is coupled to optical port 114, laser source 116, and/or illumination source 118. Generally, controller 112 is configured to control the operation of laser source 116 through various settings (such as wavelength, power or intensity, pulse width or duration, spot size, cooling, etc.), to control the operation of illumination source 118 through various settings (such as wavelength, power or intensity, etc.), to determine whether optical connector 122 of laser probe 120 is attached to optical port 114, and to perform various other functions. Controller 112 may be a microcontroller, a microprocessor, a programmable logic controller (PLC), a field programmable gate array (FPGA), an application specific integrated circuit (ASIC), etc.

Each laser source 116 is configured to generate laser light that is formed into a laser beam, such as a laser aiming beam, a laser treatment beam, etc. Similarly, each illumination source 118 is configured to generate illumination light (such as white light, a red light, etc.) that is formed into an illumination light beam. In one example, the laser light has a wavelength of about 0.1 µm (micrometers) to about 10 µm (such as about 3 µm), and may be appropriate for photoemulsification, laser vitrectomy, or other types of tissue removal. In another example, the laser light has a wavelength appropriate for photocoagulation to treat retinal tears and detachments, etc.

Generally, laser probe 120 may be used in a variety of ophthalmic surgical procedures, such as photocoagulation in retinal surgery, photoemulsification in cataract surgery, vitrectomy, etc.

In certain embodiments, laser probe 120 includes, inter alia, optical connector 122, optical cable 124, and handpiece 126. The distal end of optical cable 124 is attached to laser probe 120, and the proximal end of optical cable 124 is attached to optical connector 122. Optical connector 122 may be attached to, and detached from, optical port 114. One or more optical fibers are located within optical cable 124, and optically couple optical connector 122 to handpiece 126. In certain embodiments, each of the one or more optical fibers may be a single-core optical fiber (SCF) or a multi-core optical fiber (MCF), such as single-crystal sapphire optical fiber made from α-Al2O3. Other fiber optical materials may also be used, such as Ti:Sapphire, Y3Al5O12 (YAG), Ho:YAG, Yb:YAG, Nd:YAG, Er:YAG, Ce:YAG, Cr:YAG, or ZrF4-BaF2-LaF3-AlF3-NaF (ZBLAN), etc.

The user, such as a surgeon, may activate and deactivate laser source 116 using a mechanical or electrical control, such as switch 128 on handpiece 126, a foot pedal, etc. The mechanical or electrical control may be coupled to controller 112 or directly to laser source 116. For example, one or more electrical signal wires located within optical cable 124 may couple switch 128 to optical connector 122, which may include an electrical connector that is configured to attach to a respective electrical connector in optical port 114.

In certain embodiments, surgical system 100 may include surgical console 130 that integrates laser subsystem 110 with additional tools and subsystems to facilitate the performance of one or more ophthalmic surgical procedures. For example, surgical console 130 may be configured to facilitate the performance of vitreoretinal procedures, cataract surgeries, corneal transplants, glaucoma surgeries, LASIK (Laser-assisted in situ keratomileusis) surgeries, refractive lens exchanges, trabeculectomies, keratotomy procedures, and/or keratoplasty surgeries, etc. One example of a console configured for performing vitreoretinal procedures is the Constellation® System available from Alcon Laboratories, Inc., Fort Worth, Texas. One example of a console configured for performing cataract surgeries is the Centurion® System available from Alcon Laboratories, Inc., Fort Worth, Texas.

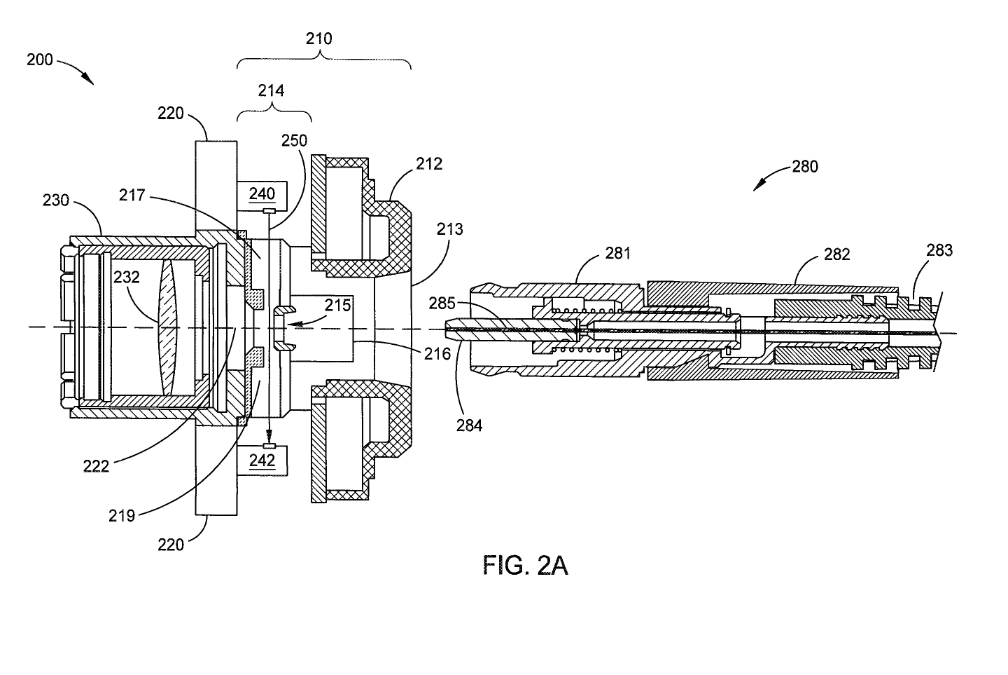

FIGS. 2A, 2B illustrate cross-sectional side views of optical port 200 and optical connector 280 in a detached configuration (FIG. 2A) and an attached configuration (FIG. 2B), in accordance with certain embodiments of the present disclosure. Optical port 200 may be representative of optical port 114, and optical connector 280 may be representative of optical connector 122 (as depicted in FIG. 1).

In certain embodiments, optical port 200 includes optical receptacle 210, circuit board 220, and optical interface 230, while optical connector 280 includes barrel member 281, sleeve 282, transition member 283, ferrule 284, and one or more optical fibers 285.

Referring to FIG. 2A, optical receptacle 210 includes, inter alia, outer body 212 and mount 214. Outer body 212 defines opening 213 that is configured to receive optical connector 280. Mount 214 defines central passage 215, transverse passage 217, and transverse passage 219. Central passage 215 is configured to receive ferrule 284 of optical connector 280. Mount 214 also defines two additional transverse passages (not visible in the sectional views) that are perpendicular to transverse passages 217, 219 and intersect transverse passages 217, 219 at central passage 215. Inner connector 216 is attached to mount 214 and is configured to receive and secure barrel member 281 of optical connector 280 within optical receptacle 210. Inner connector 216 and barrel member 281 may have cooperating circular cross sections, rectangular cross sections, etc.

Circuit board 220 is attached to optical interface 230 and defines opening 222. Mount 214 is attached to circuit board 220 using fasteners, solder, adhesive, etc., while light source 240 and optical sensor 242 are surface-mounted to circuit board 220 on opposing sides of opening 222. Light source 240 is mounted proximate to the opening of transverse passage 217, while optical sensor 242 is mounted proximate to the opening of transverse passage 219. When activated, light source 240 emits pulsed light beam 250 into transverse passage 217. When optical connector 280 is not attached to optical receptacle 210 (as depicted in FIG. 2A), pulsed light beam 250 travels along an optical path through transverse passage 217, central passage 215, and transverse passage 219 to illuminate optical sensor 242. When optical connector 280 is attached to optical receptacle 210 (as depicted in FIG. 2B), pulsed light beam 250 is blocked by ferrule 284, and pulsed light beam 250 does not illuminate optical sensor 242.

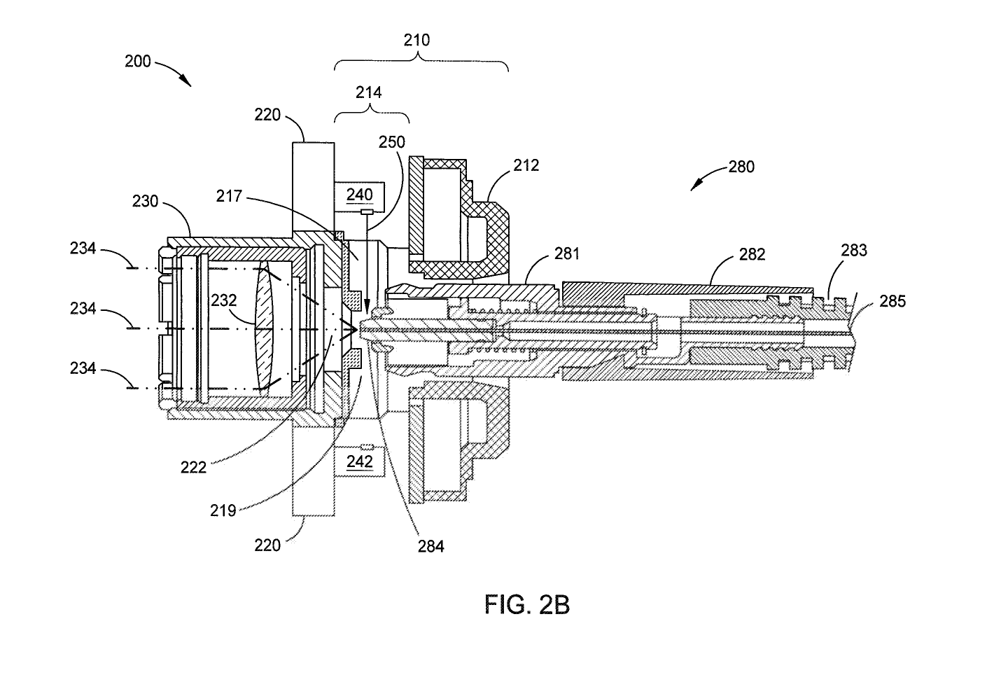

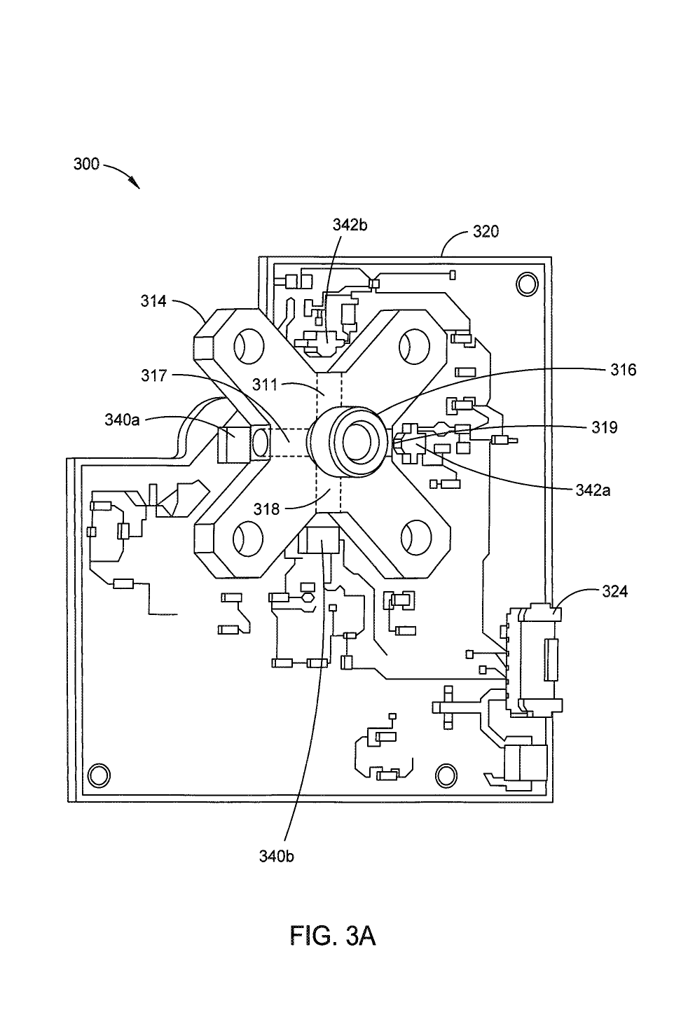

An additional light source is mounted proximate to the opening of one of the additional transverse passages, and an additional optical sensor is mounted proximate to the opening of the other additional transverse passage (as depicted in FIGS. 3A, 3B). The additional light source and optical sensor pair functions in the same manner as light source 240 and optical sensor 242. More particularly, when optical connector 280 is not attached to optical receptacle 210, the additional pulsed light beam emitted by the additional light source travels along another optical path through one of the additional transverse passages, central passage 215, and the other additional transverse passage to illuminate the additional optical sensor. When optical connector 280 is attached to optical receptacle 210, the additional pulsed light beam is blocked by ferrule 284 and does not illuminate the additional optical sensor.

Optical interface 230 includes condensing lens (or focusing lens) 232, which is configured to focus illumination and/or laser beams generated by laser subsystem 110 onto optical fiber 285 at the end of ferrule 284. Together, optical port 200 and condensing lens 232 may be referred to as a “chimney” or a “high power connector.” Optical fiber 285 may be an SCF or an MCF, as described above.

Barrel member 281 is attached to transition member 283, and surrounds, aligns, and secures ferrule 284 in the center of optical connector 280. Sleeve 282 surrounds a portion of barrel member 281 and a portion of transition member 283. Optical fiber 285 extends from the end of ferrule 284, through ferrule 284 and transition member 283, into the optical cable of the probe (such as optical cable 124) and terminates at the handpiece of the probe (such as handpiece 126). In certain embodiments, ferrule 284 may comprise a metallic tube, a ceramic tube, a sapphire tube, a single crystal tube, or other material. Optical fiber 285 may be coupled (or sealed) to ferrule 284 using a mechanical splice, a fusion splice (such as a weld), etc. For example, laser welding optical fiber 285 to ferrule 284 may provide improved chemical, mechanical, and temperature resistance while maintaining optical transmission from laser subsystem 110 to the optical fiber 285.

Referring to FIG. 2B, when optical connector 280 is attached to optical receptacle 210, the outer surface of inner connector 216 contacts the inner surface of the lower portion of barrel member 281 and forms a press fit, friction fit, interference fit, etc. (also known as a push-pull coupling), to secure optical connector 280 to optical receptacle 210. In this configuration, ferrule 284 is disposed within central passage 215 such that condensing lens 232 may converge illumination, laser aiming, and/or laser treatment beams 234 from laser subsystem 110 onto an interface plane of the end of optical fiber 285. Ferrule 284 also blocks pulsed light beam 250 from illuminating optical sensor 242.

In certain other embodiments, inner connector 216 and the lower portion of barrel member 281 may include other types of couplings or connectors, such as screw couplings, latch couplings, bayonet couplings, snap-in couplings, etc., SMA (Sub-Miniature Version A) 905 connectors, F-SMA (Fiber Sub-Miniature Version A) connectors, SC (Subscriber Connector) connectors, LC (Lucent Connector) connectors, ST (Straight tip) connectors, and MTP (Multi-fiber Termination Push-on) connectors, etc.

FIG. 3A depicts a top perspective view of a portion of an alternative optical port 300, in accordance with certain embodiments of the present disclosure. FIG. 3B depicts another top perspective view of a portion of optical port 300, in accordance with embodiments of the present disclosure.

Optical port 300 has slightly different physical characteristics than optical port 200 but performs the same functions.

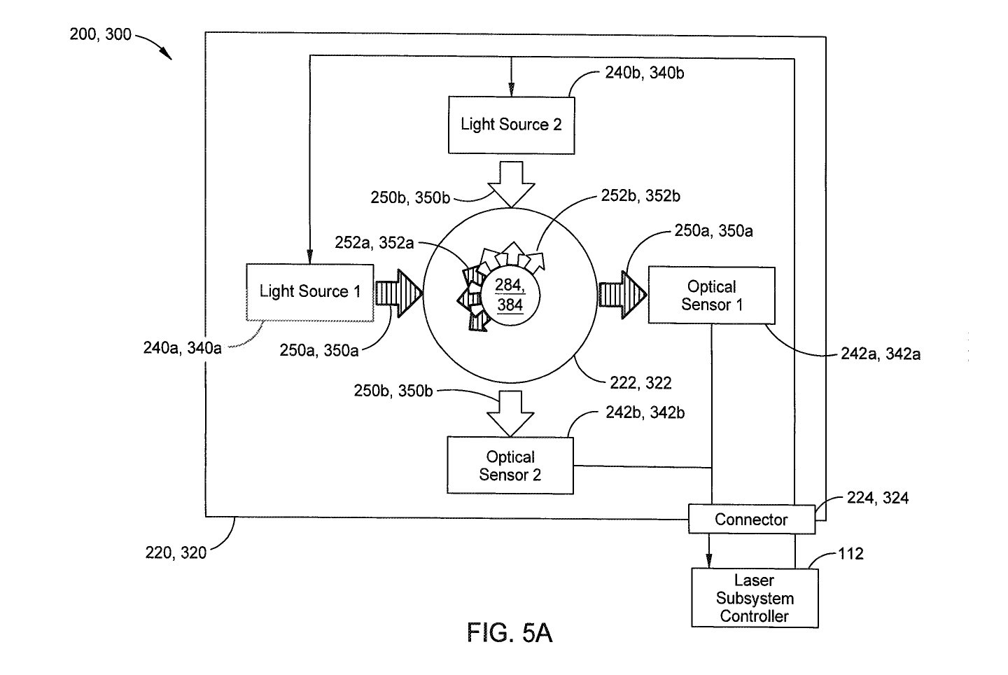

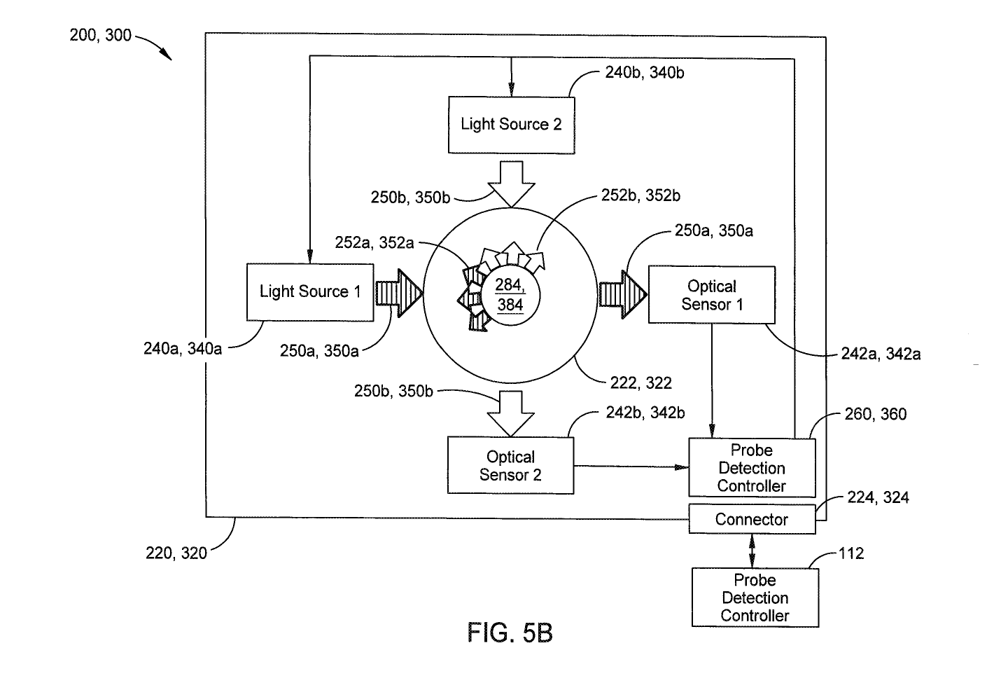

In certain embodiments, optical port 300 includes, inter alia, circuit board 320 with electrical connector 324, as well as various electrical signal wires or traces, circuit components, etc., that support two light sources 340a, 340b and two optical sensors 342a, 342b. Mount 314 defines central passage 315 (not visible) and transverse passages 317, 318, 319, 311, and includes inner connector 316 (such as an SMA 905 connector, etc.). Electrical connector 324 may be configured to convey electrical signals between circuit board 320 and a controller for laser subsystem 110, such as power, ground, timing and control signals for light sources 340a, 340b, data signals from optical sensors 342a, 342b, etc., as discussed with respect to FIGS. 5A, 5B.

Transverse passage 317, central passage 315, and transverse passage 319 form an optical path from light source 340a to optical sensor 342a. Similarly, transverse passage 318, central passage 315, and transverse passage 311 form an optical path from light source 340b to optical sensor 342b.

In some embodiments, a controller (such as probe detection controller 360 depicted in FIG. 5B) may be mounted on circuit board 320 to generate the timing and control signals for light sources 340a, 340b, and to receive and process data signals from optical sensors 342a, 342b. The controller may be a microcontroller, a microprocessor, a programmable logic controller (PLC), a field programmable gate array (FPGA), an application specific integrated circuit (ASIC), etc.

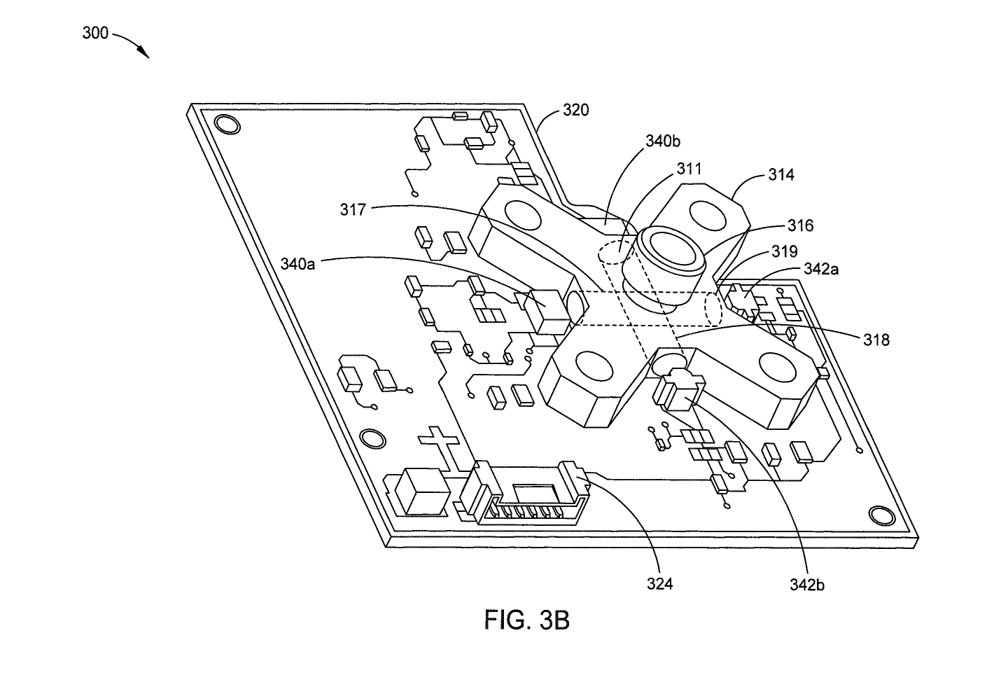

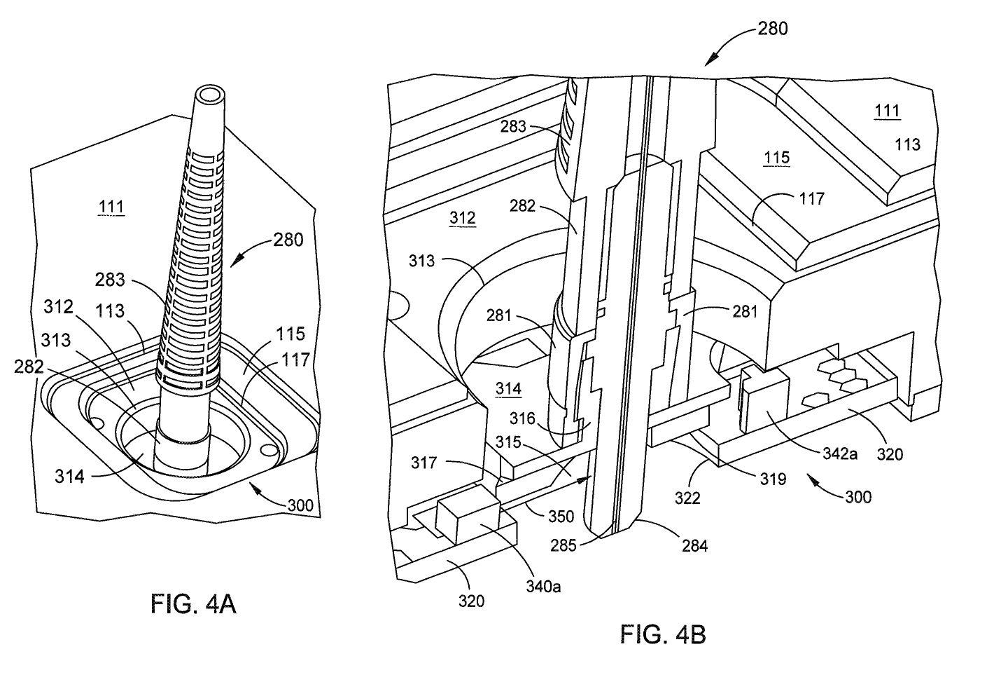

FIG. 4A depicts a perspective view of optical connector 280 attached to optical port 300, in accordance with embodiments of the present disclosure.

In certain embodiments, laser subsystem 110 includes housing 111 that defines opening 113 for optical port 300, and optical port mount plate 115 that is configured to secure optical port 300 to housing 111 and defines opening 117 for optical port 300. Outer body 312 and mount 314 of optical port 300 are identified, and outer body 312 defines opening 313 for optical connector 280. Optical connector 280 is depicted in the attached configuration, and sleeve 282 and transition member 283 are identified.

FIG. 4B depicts a perspective sectional view of optical connector 280 attached to optical port 300, in accordance with embodiments of the present disclosure.

Various components of laser subsystem 110, optical port 300, and optical connector 280 are identified, including housing 111, opening 113, optical port mount plate 115, and opening 117 of laser subsystem 110, outer body 312, opening 313, mount 314, central passage 315, inner connector 316, transverse passages 317, 319, circuit board 320, opening 322, light source 340a, and optical sensor 342a of optical port 300, and barrel member 281, sleeve 282, transition member 283, ferrule 284, and optical fiber 285 of optical connector 280.

Because optical connector 280 is attached to optical port 300, pulsed light beam 350 is blocked by ferrule 284, and pulsed light beam 350 does not illuminate optical sensor 342a.

FIG. 5A depicts a block diagram of a portion of optical port 200, 300, in accordance with embodiments of the present disclosure.

In certain embodiments, optical port 200, 300 may include two orthogonal pairs of light sources 240, 340, and optical sensors 242, 342 that are surface-mounted to circuit board 220, 320 such as light source 240a, 340a and optical sensor 242a, 342a (one pair), and light source 240b, 340b and optical sensor 242b, 342b (another pair). Due to the orthogonal arrangement of the pairs of light sources 240, 340 and optical sensors 242, 342, light source 240a, 340a does not illuminate optical sensor 242b, 342b, and light source 240b, 340b does not illuminate optical sensor 242a, 342b.

In some embodiments, the two pairs of light sources 240, 340 and optical sensors 242, 342 may be arranged at a relative angle that is less than 90°, such as 80°, 70°, etc. One or more additional pairs of light sources 240, 340 and optical sensors 242, 342 may also be provided, and all of the pairs of light sources 240, 340 and optical sensors 242, 342 may be arranged symmetrically around opening 222, 322. In certain embodiments, light sources 240a, 240b may be LEDs that emit infrared (IR) light, and optical sensors 242a, 242b may be sensors that detect IR light. In some embodiments, light sources 240a, 240b may emit different wavelengths of light, and optical sensor 242a, 242b may detect different wavelengths of light. Other types of light sources and optical sensors may also be used.

When optical connector 280 is not attached to optical port 200, 300 (also known as the detached configuration), pulsed light beam 250a, 350a emitted from light source 240a, 340a travels along an optical path and illuminates optical sensor 242a, 342a. Similarly, pulsed light beam 250b, 350b emitted from light source 240b, 340b travels along another optical path and illuminates optical sensor 242b, 342b. Due to the orthogonal arrangement of light source 240a, 340a and optical sensor 242a, 342b, and light source 240b, 340b and optical sensor 242b, 342b, the optical paths are orthogonal to one another, and cross, intersect, etc., at the center of opening 222, 322 in circuit board 220, 320.

When optical connector 280 is attached to optical port 200, 300 (also known as the attached configuration), ferrule 284 is located within the center of opening 222, 322 and blocks the optical path between light source 240a, 340a and optical sensor 242a, 342a, and blocks the optical path between light source 240b, 340b and optical sensor 242b, 342b. Consequently, pulsed light beam 250a, 350a is reflected away from optical sensor 242a, 342a by ferrule 284, and forms reflected light beam 252a, 352a. Similarly, pulsed light beam 250b, 350b is reflected away from optical sensor 242b, 342b by ferrule 284, and forms reflected light beam 252b, 352b. While reflected light beam 252a, 352a may also scatter to some degree, reflected light beam 252a, 352a does not illuminate optical sensor 242a, 342a (or optical sensor 242b, 342b) with sufficient intensity to trigger a detection event (such as a detected light intensity level above a threshold). Similarly, while reflected light beam 252b, 352b may also scatter to some degree, reflected light beam 252b, 352b does not illuminate optical sensor 242b, 342b (or optical sensor 242a, 342a) with sufficient intensity to trigger a detection event (such as a detected light intensity level above a threshold).

In certain embodiments, controller 112 (also known as laser subsystem controller 112) provides control signals to light sources 240a, 240b, 340a, 340b, and receives data signals from optical sensors 242a, 242b, 342a, 342b. Laser subsystem controller 112, along with other components, may be located on a control system circuit board for laser subsystem 110. Electrical connector 224, 324, in cooperation with electrical signal wires, traces, etc., conveys the control and data signals between the control system circuit board and circuit board 220, 320, and may convey other signals as well, such as power, ground, etc.

In certain embodiments, laser subsystem controller 112 may generate a separate control signal for each light source 240a, 240b, 340a, 340b. Each control signal includes light source activation pulses that have a time period and a pulse width, and the control signals are generated so that light source 240a, 340a and light source 240b, 340b do not emit light beam pulses at the same time. In other words, pulsed light beam 250a, 350a and pulsed light beam 250b, 350b include light beam pulses that are emitted at different times.

In certain embodiments, the control signals may be provided to light sources 240a, 240b, 340a, 340b over separate control signal lines (or traces). Similarly, laser subsystem controller 112 may receive data signals from optical sensors 242a, 242b, 342a, 342b over separate data signal lines (or traces). In some embodiments, the control signals may be provided to light sources 240a, 240b, 340a, 340b over a common signal line (or trace), and light sources 240a, 240b, 340a, 340b may include signal processing and synchronization circuitry to prevent light source 240a, 340a and light source 240b, 340b from emitting the light beam pulses of pulsed light beams 250a, 340a and 250b, 350b at the same time. Similarly, laser subsystem controller 112 may receive data signals from optical sensors 242a, 242b, 342a, 342b over a common data signal line (or trace).

Laser subsystem controller 112 may generate the control signals for light sources 240a, 240b, 340a, 340b until optical connector 280 of laser probe 120 is detected based on the data signals provided by optical sensors 242a, 242b, 342a, 342b.

FIG. 5B depicts another block diagram of a portion of optical port 200, 300, in accordance with embodiments of the present disclosure. Generally, FIG. 5B depicts the same components as FIG. 5A.

In certain embodiments, circuit board also includes controller 260, 360 (also known as probe detection controller 260, 360), which provides the control signals to light sources 240a, 240b, 340a, 340b, and receives the data signals from optical sensors 242a, 242b, 342a, 342b.

Electrical connector 224, 324, in cooperation with electrical signal wires, traces, etc., may convey control and data signals between probe detection controller 260, 360 and laser subsystem controller 112. For example, laser subsystem controller 112 may send a control signal to probe detection controller 260, 360 to start a probe detection process, and probe detection controller 260, 360 may periodically send a data signal to laser subsystem controller 112 that indicates whether optical connector 280 has been detected.

In certain embodiments, probe detection controller 260, 360 may generate a separate control signal for each light source 240a, 240b, 340a, 340b. In certain embodiments, the control signals may be provided to light sources 240a, 240b, 340a, 340b over separate control signal lines (or traces). Similarly, probe detection controller 260, 360 may receive data signals from optical sensors 242a, 242b, 342a, 342b over separate data signal lines (or traces). In some embodiments, the control signals may be provided to light sources 240a, 240b, 340a, 340b over a common signal line (or trace), and light sources 240a, 240b, 340a, 340b may include signal processing and synchronization circuitry to prevent light source 240a, 340a and light source 240b, 340b from emitting the light beam pulses of pulsed light beams 250a, 350a and 250b, 350b at the same time. Similarly, probe detection controller 260, 360 may receive data signals from optical sensors 242a, 242b, 342a, 342b over a common data signal line (or trace).

Probe detection controller 260, 360 may generate the control signals for light sources 240a, 240b, 340a, 340b until optical connector 280 of laser probe 120 is detected based on the data signals provided by optical sensors 242a, 242b, 342a, 342b.

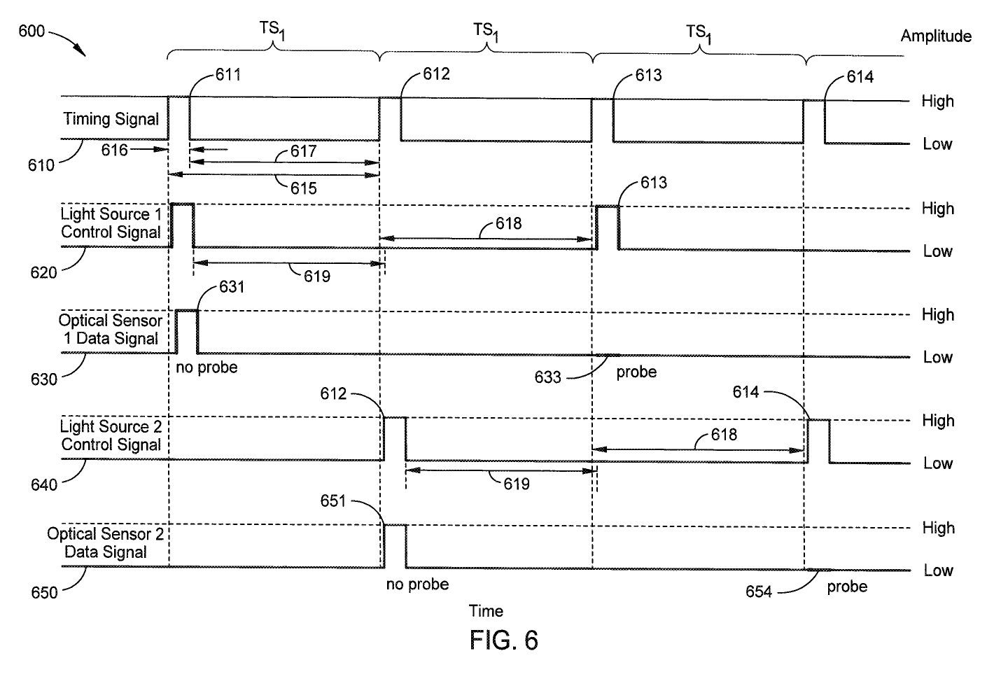

FIG. 6 depicts timing diagram 600 for the emission and reception of pulsed light beams for laser probe detection, in accordance with embodiments of the present disclosure.

In certain embodiments, laser subsystem controller 112 generates timing signal 610, which may be a digital signal that has an amplitude that changes between a high value (such as 1) and a low value (such as 0) over time. Timing signal 610 may be divided into a number of time slots TSᵢ, such as TS₁, TS₂, TS₃, TS₄, etc. Each time slot TSᵢ has a time period 615 and includes a light source activation period 616 that has a high amplitude value, and a light source deactivation period 617 that has a low value. The portion of timing signal 610 that is within light source activation period 616 may be known as a light source activation pulse, and the duration of light source activation period 616 may be known as a light source activation pulse width.

For example, time slots T₁, T₂, T₃, and T₄ include light source activation pulses 611, 612, 613, and 614, respectively. Generally, time period 615 is much greater than light source activation period 616, such as 100 times greater, 500 times greater, 1,000 times greater, etc. For example, time period 615 may be 10 ms (milliseconds), 20 ms, 50 ms, etc., while light source activation period 616 may be 10 μs (microsecond), 50 μs, 500 μs, etc. The difference between time period 615 and light source activation period 616 advantageously reduces optical degradation of light sources 240a, 240b, 340a, 340b due to the much lower duty cycle as compared to light sources that emit continuous light beams.

Laser subsystem controller 112 generates control signal 620 for light source 240a, 340a and control signal 640 for light source 240b, 340b based on timing signal 610, and, more particularly, based on light source activation periods 616 and light source deactivation periods 617 within time slots Tᵢ.

In certain embodiments, control signal 620 may include light source activation periods 616 (such as light source activation pulses 611, 613, etc.) and light source deactivation periods 617 from odd time slots T₁, T₃, etc. During even time slots T₂, T₄, etc., control signal 620 may include only light source deactivation periods 618. Similarly, control signal 640 may include light source activation periods 616 (such as light source activation pulses 612, 614, etc.) and light source deactivation periods 617 from even time slots T₂, T₄, etc. During odd time slots T₁, T₃, etc., control signal 640 may include only light source deactivation periods 618. Light source 240a, 340a emits a light beam pulse in response to each light source activation pulse 611, 613, etc., and light source 240b, 340b emits a light beam pulse in response to each light source activation pulse 612, 614, etc. The light beam pulses have the same duration as the light source activation pulses.

Accordingly, light source 240a, 340a emits a light beam pulse once every two time periods (such as every odd time slot T_{odd}), and light source 240b, 340b emits a light beam pulse once every two time periods (such as even time slots Tₑᵥₑₙ). In other words, one light beam pulse is emitted by light source 240a, 340a or one light beam pulse is emitted by light source 240b, 340b every time period, and the light beam pulses emitted by light source 240a, 340a and the light beam pulses emitted by light source 240b, 340b alternate every time period. While an alternating light beam pulse sequence between control signal 620 and control signal 640 has been described, other mapping sequences are also supported, such as emitting one light beam pulse every two odd time slots for control signal 620 and emitting one light beam pulse every two even time slots for control signal 640, emitting one light beam pulse every three odd time slots for control signal 620 and emitting one light beam pulse every three even time slots for control signal 640, etc.

Control signal 620 is depicted at the time of reception by light source 240a, 340a, and therefore, light source activation pulse 611 is slightly delayed from the start of time slot TS₁, and light source activation pulse 613 is slightly delayed from the start of time slot TS₃. Similarly, control signal 640 is depicted at the time of reception by light source 240b, 340b, and therefore light source activation pulse 612 is slightly delayed from the start of time slot TS₂, and light source activation pulse 614 is slightly delayed from the start of time slot TS₄.

The end of each light source activation pulse is separated from the beginning of the successive light activation pulse by quiescent time 619, during which time light is not emitted by light source 240a, 340a and the light source 240b, 340b. For example, quiescent time 619 separates the end of light source activation pulse 611 from the beginning of light source activation pulse 612, separates the end of light source activation pulse 612 from the beginning of light source activation pulse 613, etc.

Generally, control signals 620, 640 may be transistor-transistor logic (TTL) signals that have a low value between 0 V (volts) and about 0.8 V, and a high value of greater than 3 V (such as 3.3 V, 5 V, etc.). In certain embodiments, timing signal 610 may be a pulse width modulation (PWM) signal, and laser subsystem controller 112 may include a PWM controller that generates timing signal 610. For PWM signals, the proportion of light source activation period 616 to time period 615 may be known as the duty cycle.

Optical sensors 242a, 342a and 242b, 342b generate data signals 630, 650 in response to illumination by the light beam pulses of pulsed light beams 250a, 350a and 250b, 350b (respectively), which are provided to laser subsystem control 112. More particularly, data signal 630 may be a digital signal that has an amplitude that changes between a high signal level (such as 1) when optical sensor 242a, 342a is illuminated above a threshold intensity by light source 240a, 340a (such as a light beam pulse), and a low signal level (such as 0) when optical sensor 242a, 342a is not illuminated above the threshold intensity by light source 240a, 340a. Similarly, data signal 650 may be a digital signal that has an amplitude that changes between a high signal level (such as 1) when illuminated above a threshold intensity by light source 240b, 340b (such as a light beam pulse), and a low signal level (such as 0) when not illuminated above the threshold intensity by light source 240b, 340b.

During time slot TS₁, light sources 240a, 340a and 240b, 340b are not blocked by ferrule 284, control signal 620 includes light source activation pulse 611, and control signal 640 does not include a light activation pulse. Light source 240a, 340a emits pulsed light beam 250a, 350a (with a single light beam pulse) in response to receiving control signal 620, and light source 240b, 340b emits pulsed light beam 250b, 350b (without a light beam pulse) in response to receiving control signal 640. While light source 240b, 340b is described as “emitting” pulsed light beam 250b, 350b, no light is actually emitted due to the absence of a light activation pulse within control signal 640. Optical sensor 242a, 342a receives pulsed light beam 250a, 350a from light source 240a, 340a, and generates data signal 630 that includes response pulse 631 that corresponds to light source activation pulse 611. Optical sensor 242b, 342b receives pulsed light beam 250b, 350b from light source 240b, 340b, and generates data signal 650 that does not include a response pulse due to the absence of a light beam pulse.

During time slot TS₂, light sources 240a, 340a and 240b, 340b are not blocked by ferrule 284, control signal 620 does not include a light activation pulse, and control signal 640 includes light source activation pulse 612. Light source 240b, 340b emits pulsed light beam 250b, 350b (with a single light beam pulse) in response to receiving control signal 640, and light source 240a, 340a emits pulsed light beam 250a, 350a (without a light beam pulse) in response to receiving control signal 620. While light source 240a, 340a is described as “emitting” pulsed light beam 250a, 350a, no light is actually emitted due to the absence of a light activation pulse within control signal 620. Optical sensor 242b, 342b receives pulsed light beam 250b, 350b from light source 240b, 340b, and generates data signal 650 that includes response pulse 651 that corresponds to light source activation pulse 612. Optical sensor 242a, 342a receives pulsed light beam 250a, 350a from light source 240a, 340a, and generates data signal 630 that does not include a response pulse due to the absence of a light beam pulse.

During time slot TS₃, light sources 240a, 340a and 240b, 340b are blocked by ferrule 284, control signal 620 includes light source activation pulse 613, and control signal 640 does not include a light activation pulse. Light source 240a, 340a emits pulsed light beam 250a, 350a (with a single light beam pulse) in response to receiving control signal 620, and light source 240b, 340b emits pulsed light beam 250b, 350b (without a light beam pulse) in response to receiving control signal 640. Due to ferrule 284, optical sensor 242a, 342a does not receive pulsed light beam 250a, 350a from light source 240a, 340a, and generates data signal 630 that does not include a response pulse that corresponds to light source activation pulse 613. Optical sensor 242b, 342b generates data signal 650 that does not include a response pulse due to the absence of a light beam pulse (which would have been blocked by ferrule 284).

During time slot TS₄, light sources 240a, 340a and 240b, 340b are blocked by ferrule 284, control signal 620 does not include a light activation pulse, and control signal 640 includes light source activation pulse 614. Light source 240b, 340b emits pulsed light beam 250b, 350b (with a single light beam pulse) in response to receiving control signal 640, and light source 240a, 340a emits pulsed light beam 250a, 350a (without a light beam pulse) in response to receiving control signal 620. Due to ferrule 284, optical sensor 242b, 342b does not receive pulsed light beam 250b, 350b from light source 240b, 340b, and generates data signal 650 that does not include a response pulse that corresponds to light source activation pulse 614. Optical sensor 242a, 342a generates data signal 630 that does not include a response pulse due to the absence of a light beam pulse (which would have been blocked by ferrule 284).

Data signal 630 is depicted at the time of reception by laser subsystem controller 112, so response pulse 631 is slightly delayed from the start of light source activation pulse 611. Data signal 650 is similarly depicted at the time of reception by laser subsystem controller 112, so response pulse 651 is slightly delayed from the start of light source activation pulse 612.

In certain embodiments, data signals 630, 650 may be transistor-transistor logic (TTL) signals that have a low signal level between 0 V and about 0.8 V, and a high signal level of greater than 3 V (such as 3.3 V, 5 V, etc.).

While timing diagram 600 has been discussed with respect to laser subsystem controller 112, probe detection controller 260, 360 may generate timing signal 610 and control signals 620, 640, and receive data signals 630, 650. Laser subsystem controller 112 may send a control signal to probe detection controller 260, 360 to start the probe detection process, and probe detection controller 260, 360 may periodically send a data signal to laser subsystem controller 112 that indicates whether optical connector 280 has been detected.

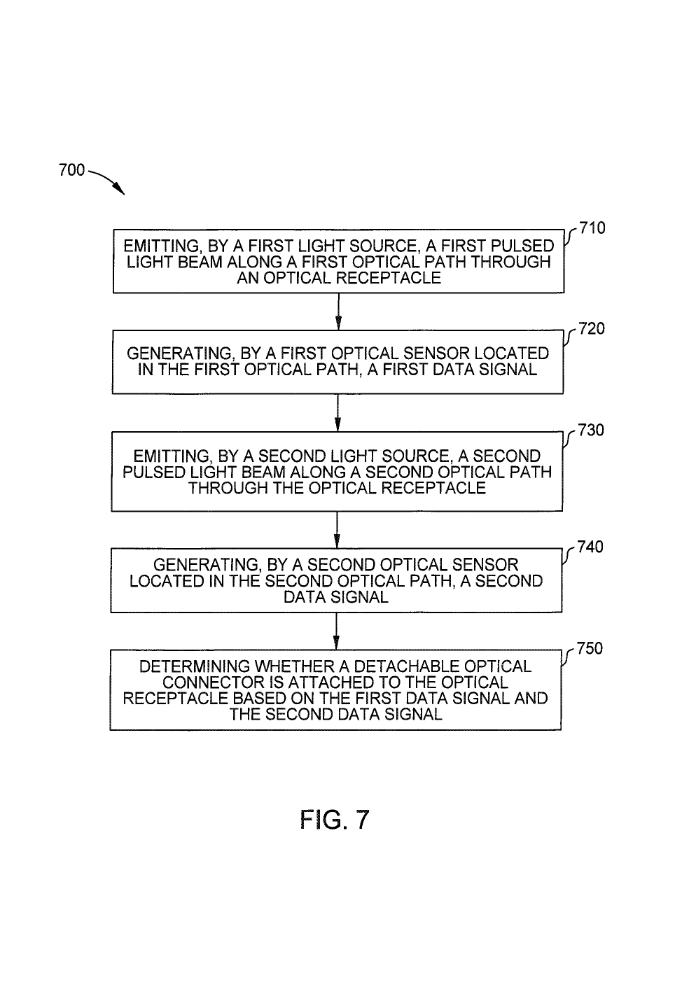

FIG. 7 depicts process flow diagram 700 presenting functionality associated with detecting a probe in a laser-based surgical system, in accordance with embodiments of the present disclosure.

At 710, light source 240a, 340a emits pulsed light beam 250a, 350a along an optical path through optical receptacle 210, 310, such as the optical path through transverse passage 217, 317, central passage 215, 315, and transverse passage 219, 319.

At 720, optical sensor 242a, 342a generates data signal 630. Optical sensor 242a, 342a is located in the optical path.

At 730, light source 240b, 340b emits pulsed light beam 250b, 350b along another optical path through optical receptacle 210, 310, such as the optical path through transverse passage 318, central passage 315, and transverse passage 311. Pulsed light beam 250a, 350a and pulsed light beam 250b, 350b include light beam pulses that are emitted at different times, as discussed above.

At 740, optical sensor 242b, 342b generates data signal 650. Optical sensor 242b, 342b is located in the other optical path.

At 750, laser subsystem controller 112 (or probe detection controller 260, 360) determines whether detachable optical connector 280 of laser probe 120 is attached to optical receptacle 210, 310 based on data signal 630 and data signal 650.

In certain embodiments, detachable optical connector 280 is determined to be attached when response pulses are absent from both data signal 630 and data signal 650. In other embodiments, detachable optical connector 280 is determined to be attached when response pulses are absent from data signal 630 or data signal 650. Alternatively, laser subsystem controller 112 may determine that detachable optical connector 280 is detached when response pulses are present in both data signal 630 and data signal 650.

### Example Embodiments

In certain embodiments, a system comprises an optical port and a controller coupled to the optical port. The optical port includes an optical receptacle configured to receive a detachable optical connector, a first light source configured to emit a first pulsed light beam along a first optical path through the optical receptacle in response to a first control signal, a first optical sensor located in the first optical path, the first optical sensor configured to receive the first pulsed light beam and generate a first data signal, a second light source configured to emit a second pulsed light beam along a second optical path through the optical receptacle in response to a second control signal, and a second optical sensor located in the second optical path, the second optical sensor configured to receive the second pulsed light beam and generate a second data signal. The controller is configured to generate the first control signal, generate the second control signal, and determine whether a detachable optical connector is attached to the optical port based on the first data signal and the second data signal. The detachable optical connector blocks the first optical path and the second optical path when the detachable optical connector is attached to the optical receptacle. The first pulsed light beam includes first light beam pulses, the second pulsed light beam includes second light beam pulses, and the first and second light beam pulses are emitted at different times.

In certain embodiments, a method for detecting a probe comprises emitting, by a first light source, a first pulsed light beam along a first optical path through an optical receptacle; generating, by a first optical sensor located in the first optical path, a first data signal; emitting, by a second light source, a second pulsed light beam along a second optical path through the optical receptacle; generating, by a second optical sensor located in the second optical path, a second data signal; determining whether a detachable optical connector is attached to the optical receptacle based on the first data signal and the second data signal. When the detachable optical connector is attached to the optical receptacle, the detachable optical connector blocks the first optical path and the second optical path. The first pulsed light beam includes first light beam pulses, the second pulsed light beam includes second light beam pulses, and the first and second light beam pulses are emitted at different times.

In certain embodiments, an optical port comprises an optical receptacle configured to receive a detachable optical connector; a first light source configured to emit a first pulsed light beam along a first optical path through the optical receptacle; a first optical sensor located in the first optical path, the first optical sensor configured to receive the first pulsed light beam and generate a first data signal; a second light source configured to emit a second pulsed light beam along a second optical path through the optical receptacle; and a second optical sensor located in the second optical path, the second optical sensor configured to receive the second pulsed light beam and generate a second data signal. The detachable optical connector blocks the first optical path and the second optical path when the detachable optical connector is attached to the optical receptacle. The first pulsed light beam includes first light beam pulses, the second pulsed light beam includes second light beam pulses, and the first and second light beam pulses are emitted at different times.

The many features and advantages of the disclosure are apparent from the detailed specification, and, thus, it is intended by the appended claims to cover all such features and advantages of the disclosure which fall within the scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A system, comprising:
an optical port, including:
an optical receptacle configured to receive a detachable optical connector,
a first light source configured to emit a first pulsed light beam along a first optical path through the optical receptacle in response to a first control signal,
a first optical sensor located in the first optical path, the first optical sensor configured to receive the first pulsed light beam and generate a first data signal,
a second light source configured to emit a second pulsed light beam along a second optical path through the optical receptacle in response to a second control signal, and
a second optical sensor located in the second optical path, the second optical sensor configured to receive the second pulsed light beam and generate a second data signal; and
a controller, coupled to the optical port, the controller configured to:
generate the first control signal,
generate the second control signal, and
determine whether a detachable optical connector is attached to the optical port based on the first data signal and the second data signal,
wherein the detachable optical connector blocks the first optical path and the second optical path when the detachable optical connector is attached to the optical receptacle, and
wherein the first pulsed light beam includes first light beam pulses, the second pulsed light beam includes second light beam pulses, and the first and second light beam pulses are emitted at different times.

2. The system of claim 1, wherein:
the detachable optical connector includes a barrel member and a ferrule that extends from the barrel member; and
the ferrule blocks the first pulsed light beam and the second pulsed light beam when the detachable optical connector is attached to the optical port.

3. The system of claim 2, wherein:
the second pulsed light beam is perpendicular to the first pulsed light beam and intersects the first pulsed light beam at a location occupied by the ferrule when the detachable optical connector is attached to the optical port.

4. The system of claim 3, wherein:
a circuit board defining an opening,
wherein:
the optical port includes a mount attached to the circuit board,
the mount defines a central passage that is aligned with the opening, the central passage configured to receive the ferrule,
the first light source and the first optical sensor are surface-mounted to the circuit board on first opposing sides of the opening, and
the second light source and the second optical sensor are surface-mounted to the circuit board on second opposing sides of the opening.

5. The system of claim 4, wherein:
the mount defines a first passage for the first pulsed light beam,
the mount defines a second passage for the second pulsed light beam, the second passage perpendicular to the first passage, and
the first passage and the second passage intersect at the central passage.

6. The system of claim 1, wherein:
the first optical sensor is configured to generate a first signal level when a first light beam pulse is received, and a second signal level when a first light beam pulse is not received; and
the second optical sensor is configured to generate the first signal level when a second light beam pulse is received, and the second signal level when a second light beam pulse is not received.

7. The system of claim 1, wherein:
the different times are separated by a time period; and
one first light beam pulse or one second light beam pulse is emitted every time period.

8. The system of claim 7, wherein the first light beam pulses and the second light beam pulses alternate every time period.

9. The system of claim 8, wherein the first light beam pulses and the second light beam pulses are separated by a quiescent time during which light is not emitted by the first light source and the second light source.

10. The system of claim 9, wherein:
the first light beam pulses and the second light beam pulses have a pulse width; and
the time period is about 1,000 times greater than the pulse width.

11. A method for detecting a probe, comprising:
emitting, by a first light source, a first pulsed light beam along a first optical path through an optical receptacle;
generating, by a first optical sensor located in the first optical path, a first data signal;
emitting, by a second light source, a second pulsed light beam along a second optical path through the optical receptacle;
generating, by a second optical sensor located in the second optical path, a second data signal;
determining whether a detachable optical connector is attached to the optical receptacle based on the first data signal and the second data signal,
wherein, when the detachable optical connector is attached to the optical receptacle, the detachable optical connector blocks the first optical path and the second optical path, and
wherein the first pulsed light beam includes first light beam pulses, the second pulsed light beam includes second light beam pulses, and the first and second light beam pulses are emitted at different times.

12. The method of claim 11, wherein:
generating the first data signal includes generating a first signal level when a first light beam pulse is received, and generating a second signal level when a first light beam pulse is not received; and
generating the second data signal includes generating the first signal level when a second light beam pulse is received, and generating the second signal level when a second light beam pulse is not received.

13. The method of claim 12, wherein:
the different times are separated by a time period;
emitting the first pulsed light beam includes emitting a first light beam pulse every two time periods; and
emitting the second pulsed light beam includes emitting a second light beam pulse every two time periods.

14. The method of claim 13, wherein:
the first light beam pulses and the second light beam pulses alternate every time period; and
the first light beam pulses and the second light beam pulses are separated by a quiescent time during which light is not emitted by the first light source and the second light source.

15. The method of claim 14, wherein:
the first light beam pulses and the second light beam pulses have a pulse width; and
the time period is about 1,000 times greater than the pulse width.
